(19) United States
(12) Patent Application Publication
(10) Pub. No.: US 2022/0067699 A1
(43) Pub. Date: Mar. 3, 2022

(54) SYSTEMS AND METHODS FOR USE IN AUTHENTICATING USERS BASED ON LOCATION

(71) Applicant: MASTERCARD INTERNATIONAL INCORPORATED, Purchase, NY (US)

(72) Inventors: Bernard Wong, Markham, Ontario (CA); Ellen Moskowitz, Port Chester, NY (US); Emily Anne Stepper, Nyack, NY (US)

(21) Appl. No.: 17/008,092

(22) Filed: Aug. 31, 2020

(51) Int. Cl. G06Q 20/34; G06Q 20/40; G06Q 20/32; G06F 21/32

(52) U.S. Cl. CPC G06Q 20/341; G06Q 20/40145; G06F 21/32; G06Q 20/3224; G06Q 20/4015

(57) ABSTRACT

Systems and methods for verifying users in connection with transactions using payment card devices are disclosed. One exemplary payment card device generally includes a card body, a modem, and a processor disposed on the card body and coupled to the modem. The processor, then, is configured to determine a location of the payment card device, via at least the modem, based on multiple signals from multiple towers (and/or routers) associated with a telecommunication network, and transmit, by the modem, via one of the multiple towers and/or routers, location data indicative of the determined location to at least one of an issuer of the payment account and/or a payment network associated with the payment account.

### FIELD

The present disclosure generally relates to systems and methods for use in authenticating users, and more specifically, to systems and methods for use in reporting locations associated with card devices of users, which are then used to authenticate the users.

### BACKGROUND

This section provides background information related to the present disclosure which is not necessarily prior art.

Accounts are known to be issued to users. The accounts may be used for a variety of purposes, including funding transactions with merchants, etc. (i.e., where the accounts are payment accounts). Often, the users of the accounts are authenticated prior to such use to ensure that the users are linked to the accounts and are permitted to utilize the accounts, for example, to fund the transactions. Traditional methods of authentication include signature or PIN authentication. More recently, biometrics have been used, at merchant locations, to authenticate users to their accounts.

### DRAWINGS

The drawings described herein are for illustrative purposes only of selected embodiments and not all possible implementations, and are not intended to limit the scope of the present disclosure.

FIG. 1 illustrates an exemplary system of the present disclosure suitable for use in authenticating a user based on a location of a payment card device associated with the user;

FIG. 2 is a block diagram of an exemplary computing device that may be used in the system of FIG. 1;

FIG. 3 is a block diagram of an exemplary payment card device that may be used in the system of FIG. 1, where the payment card device includes a modem; and

FIG. 4 is an exemplary method, suitable for use with the system of FIG. 1, for authenticating a user via location data delivered from a payment card device associated with the user to an issuer of a payment account with which the payment card device is associated.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Authenticating users to payment accounts is important and necessary to ensure that only users authorized to use the payment accounts are permitted to, in fact, use the payment accounts. Certain types of authentication (e.g., based on biometrics, etc.) are understood to be more reliable and/or less susceptible to being faked and/or defeated than others. In addition, some payment accounts require multi-factor authentication in order to access the accounts. As different authentication methods are proliferated, the technology involved in facilitating account transactions may lag behind (as being unable to support the different authentication methods), whereby the authentication methods are ultimately not used for transactions. In such instances, other types of authentication may be imposed and/or relied upon to gain confidence in authentication of users.

Uniquely, the systems and methods herein provide payment card devices, which include modems (e.g., cellular or mobile network modems, wireless enabled modems (e.g., Wi-Fi enabled, etc.), combinations thereof, etc.), whereby the payment card devices are enabled to provide information (e.g., location data, authentication results, etc.) to an entity associated with authenticating users in connection with transactions performed using the payment devices. In particular, one example of the payment card devices includes a modem, which is enabled for cellular communication, whereby the payment card device is able to report a location of the card device (e.g., during transactions, at other times when transactions are not being performed, etc.). The location of the payment card device may then be used, by an issuer of the payment account linked to the payment card device, as a basis to authenticate the user in connection with a transaction. In this manner, when biometric authentication is not available at a POS terminal, for example, the issuer of the user's payment account is provided further information in connection with the transaction being performed by the user upon which to decide to approve or decline the transaction.

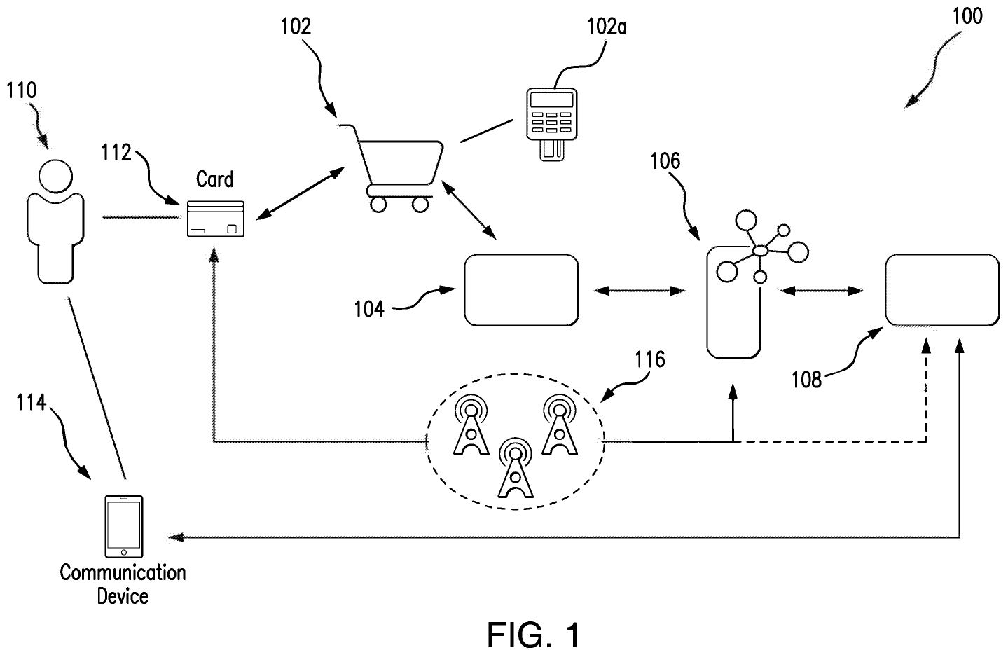

FIG. 1 illustrates an exemplary system 100 in which one or more aspects of the present disclosure may be implemented. Although parts of the system 100 are presented in one arrangement, it should be appreciated that other exemplary embodiments may include the same or different parts arranged otherwise, depending on, for example, processes involved in authenticating users in the system, types of modems and/or telecommunication providers or carriers involved in the system, available wireless networks, etc.

As shown in FIG. 1, the illustrated system 100 generally includes a merchant 102, an acquirer 104 associated with the merchant 102, a payment network 106, and an issuer 108 of payment accounts, each coupled to (and in communication with) one or more networks, as indicted by the arrowed lines (where the one or more networks may be part of the same network or not). Each of the one or more networks may include, without limitation, a wired and/or wireless network, a local area network (LAN), a wide area network (WAN) (e.g., the Internet, etc.), a mobile network, and/or another suitable public and/or private network capable of supporting communication among two or more of the illustrated components of the system 100, or any combination thereof. The networks may further be segregated or separated, whereby, for example, the networks may include a private payment transaction network provided by the payment network 106 to the acquirer 104 and the issuer 108, and separately, a public network (e.g., the Internet, etc.) through which the merchant 102 and/or a user 110 communicate, or through which the merchant 102 communicates with the acquirer 104, the payment network 106, or the issuer 108. It should be appreciated that various ones of the illustrated components may also communicate with other ones of the components even if an arrowed line is not shown, via one or more networks (e.g., communication device 114 may communicate with the merchant 102 as desired vie one or more networks, etc.).

The merchant 102 in the system 100 generally includes a POS terminal 102a, which permits transactions funded by payment accounts (as issued by the issuer 108 or another entity) to be initiated at the merchant 102. In connection therewith, the user 110 (and other users) may interact with the merchant 102, and in particular the POS terminal 102a, to facilitate such transactions between the merchant 102 and the user 110 for products from the merchant 102, including, for example, goods and services.

In addition, in the illustrated embodiment the acquirer 104 includes a banking institution or other financial institution, which has issued an account to the merchant 102, whereby funds associated with payment account transactions to the merchant 102 are delivered. The payment account may include, for example, a credit account, a debit account (e.g., a checking account or savings account, etc.), or a prepaid account, etc. In a similar manner, the issuer 108 includes a banking institution or other financial institution, which has issued the payment account to the user 110, and through which the user 110 is permitted to fund transactions with the merchant 102 and other merchants.

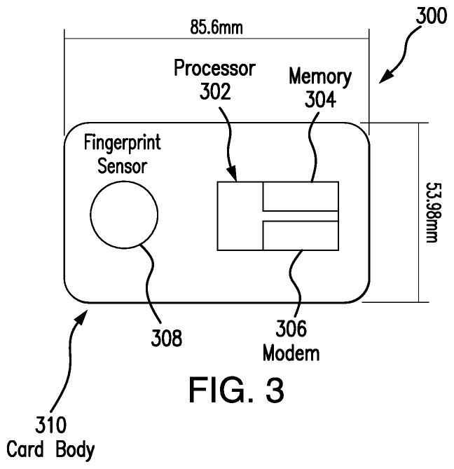

When the payment account is issued to the user 110, by the issuer 108, the issuer 108 also provides a payment card device 112 to the user 110 whereby the user 110 can use the payment card device 112 to initiate transactions to the payment account. The payment card device 112 includes, in general, a payment card, which complies with, in this embodiment, the ISO/IEC 7810 ID-1 standard, which generally indicates the particular physical dimensions and/or dimensional proportions of the payment card device 112 (i.e., which is the payment card in this instance) (e.g., a first dimension (either length or width) of about 85.60 mm (about 3.37 inches) and a second dimension (the other of length or width) of about 53.98 mm (about 2.13 inches), and a thickness dimension of about 0.76 mm (about 0.03 inches); etc.). Of course, however, other payment device embodiments may be constructed according to one or more different standards (e.g., ISO/IEC 7810 ID-2, ISO/IEC 7810 ID-3, ISO/IEC 7810 ID-000, etc.). That said, in one or more embodiments, payment card devices herein may have (without limitation) dimensions (lengths and/or widths) ranging between about 15 mm (about 0.59 inches) and about 150 mm (about 5.91 inches), and thicknesses ranging from about 0.1 mm (about 0.004 inches) to about 1 mm (about 0.04 inches). In addition, in this exemplary embodiment, the payment card device 112 is configured to capture one or more biometrics of the user 110 as desired (such that the payment card device 112 may be considered a biometric payment card device, etc.). That said, the payment card device 112 is generally consistent with the example payment card device 300 illustrated in FIG. 3, which is described in more detail hereinafter.

Also shown in FIG. 1, the system 100 includes a series of telecommunication towers 116 (broadly, intermediary devices), which are configured to support communication between the payment card device 112 and the payment network 106 and/or the issuer 108 (in a manner that generally goes around the merchant 102 and the acquirer 104, and that does not go through or involve the merchant 102 or the acquirer 104). That is, the series of towers 116 is configured as an intermediary to support the communication therebetween between. The series of telecommunication towers may be owned and/or operated by one or more carriers, such as, for example, Verizon, Sprint, T Mobile, or other suitable entities, etc. It should be appreciated that in other embodiments the series of towers illustrated in FIG. 1 may be replaced by routers (broadly, intermediary devices) disposed over a geographic region. It should further be appreciated that the series of towers 116 may also be configured to support communication between the communication device 114 and the issuer 108, or, alternatively, a different series of towers or a different means of communication (e.g., wireless communication, etc.) may be used.

With continued reference to FIG. 1, the user 110 is also associated with the communication device 114 in the system 100. In addition to supporting conventional use (e.g., whereby the communication device 114 is configured to facilitate phone calls, send and receive short message service (SMS) messages, etc. as is generally understood by those skilled in the art, etc.), the communication device 114 is further configured to access and allow the user 110 to send and/or receive messaging to and/or from the issuer 108 (via one or more networks, etc.). In connection therewith, the communication device 114 may include, for example, a network-based application (not shown) associated with and/or provided by the issuer 108, which configures the communication device 114 to operate as described herein (and allows such communication with the issuer 108). It should be appreciated that the communication device 114 may communicate through one or more networks, including, for example, cellular or mobile network, private wireless networks, etc. The communication device 114 may include, for example, a smartphone, a tablet, a laptop, or other portable computing device (or other computing device), etc.

While only one merchant 102 and one user 110 (and one payment card device 112 and one communication device 114) are illustrated in FIG. 1, it should be appreciated that any number of merchants and/or users, as described herein, may be included in other embodiments. Likewise, a different number of, acquirers, payment networks, and issuers may be included in other embodiments. Further, in various embodiments, the merchant 102 will often include multiple POS terminals, for example. In still other embodiments, different merchants may have different acquirers, and different users may employ payment accounts issued by multiple different issuers.

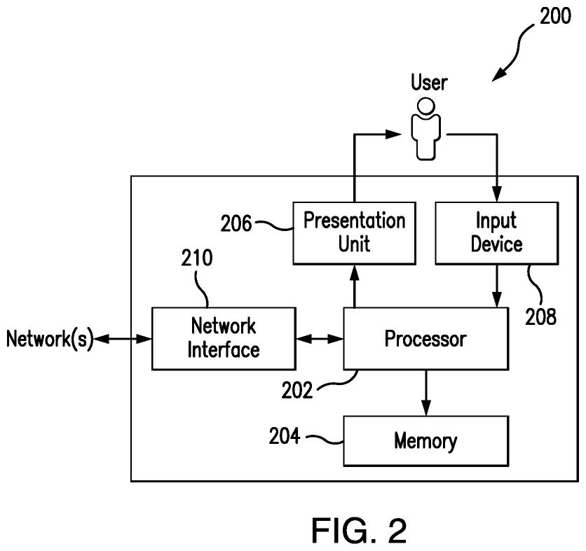

FIG. 2 illustrates exemplary computing device 200 that can be used in the system 100. The computing device 200 may include, for example, one or more servers, workstations, personal computers, laptops, tablets, smartphones, other communication devices, POS terminals, payment devices, etc. In addition, the computing device 200 may include a single computing device, or it may include multiple computing devices located in close proximity or distributed over a geographic region, so long as the computing devices are specifically configured to function as described herein. In particular, in the exemplary system 100 of FIG. 1, each of the merchant 102 (or more specifically, the POS terminal 102a at the merchant 102), the acquirer 104, the payment network 106, and the issuer 108, may include, or may be implemented in, a computing device such as the computing device 200. In addition, the payment card device 112 and the communication device 114 associated with the user 110 may each be considered a computing device consistent with the computing device 200. That said, the system 100 should not be considered to be limited to the computing device 200, as described below, as different computing devices and/or arrangements of computing devices may be used. In addition, different components and/or arrangements of components may be used in other computing devices.

With reference now to FIG. 2, the computing device 200 generally includes a processor 202, and a memory 204 that is coupled to (and in communication with) the processor 202. The processor 202 may include, without limitation, one or more processing units (e.g., in a multi-core configuration, etc.), including a general purpose central processing unit (CPU), a microcontroller, a reduced instruction set computer (RISC) processor, an application specific integrated circuit (ASIC), a programmable logic device (PLD), a gate array, and/or any other circuit or processor capable of the functions described herein. The above examples are exemplary only, and are not intended to limit in any way the definition and/or meaning of processor.

The memory 204, as described herein, is one or more devices that enable information, such as executable instructions and/or other data, to be stored and retrieved. The memory 204 may be configured to store, without limitation, transaction data, location data, primary account numbers (e.g., PANs, etc.) and/or other payment account credentials, reference biometrics, authorization messages, authentication messages, and/or other types of data suitable for use as described herein, etc. In addition, the memory 204 may include one or more computer-readable storage media, such as, without limitation, dynamic random access memory (DRAM), static random access memory (SRAM), read only memory (ROM), erasable programmable read only memory (EPROM), solid state devices (e.g., EMV chips, etc.), CD-ROMs, thumb drives, tapes, flash drives, hard disks, and/or any other type of volatile or nonvolatile physical or tangible computer-readable media. It should be appreciated that the memory 204 may include a variety of different memories. In various embodiments, computer-executable instructions may be stored in the memory 204 for execution by the processor 202 to cause the processor 202 to perform one or more of the operations described herein (e.g., one or more of the operations recited in method 400, etc.), such that the memory 204 is a physical, tangible, and non-transitory computer-readable media and such that the instructions stored in the memory 204 enable the computing device to operate as (or transform the computing device into) a specific-purpose device configured to then effect the features described herein.

The computing device 200 also includes a presentation unit 206 and an input device 208 coupled to (and in communication with) the processor 202.

The presentation unit 206 outputs information and/or data to a user (e.g., the user 110, other users, etc.) by, for example, displaying, audibilizing, and/or otherwise outputting the information and/or data. In some embodiments, the presentation unit 206 may comprise a display device such that various interfaces (e.g., application screens, webpages, etc.) may be displayed at computing device 200, and in particular at the display device, to display such information and/or data, etc. With that said, the presentation unit 206 may include, without limitation, a cathode ray tube (CRT), a liquid crystal display (LCD), a light-emitting diode (LED) display, an organic LED (OLED) display, an “electronic ink” display, speakers, combinations thereof, etc. In addition, the presentation unit 206 may include multiple devices in some embodiments.

The input device 208, when present in the computing device 200, is configured to receive input from the user 110, for example. The input device may include, without limitation, a keyboard, a mouse, a touch sensitive panel (e.g., a touch pad or a touch screen, etc.), another computing device, and/or an audio input device. Further, in some exemplary embodiments, a touch screen, such as that included in a tablet, a smartphone, or similar device, may function as both the presentation unit 206 and the input device 208.

The illustrated computing device 200 further includes a network interface 210 coupled to (and in communication with) the processor 202 and the memory 204. The network interface 210 may include, without limitation, a wired network adapter, a wireless network adapter, a mobile adapter, or other device capable of communicating to one or more different networks (e.g., the Internet, a private or public LAN, WAN, mobile network, combinations thereof, or other suitable network, etc.), or separate therefrom. In some exemplary embodiments, the processor 202 and one or more network interfaces may be incorporated together. In this manner, and others, for example, network interface 210 may be generally consistent with modem 306 illustrated in the payment card device 300 of FIG. 3.

Referring again to FIG. 1, the payment card device 112 may be used at one or multiple different terminals in the system 100, including the POS terminal 102a associated with the merchant 102, to perform as described herein. In addition, the payment card device 112 is associated, specifically, with user 110 and is associated with (or linked to) the payment account of the user 110, issued by the issuer 108. The payment card device 112 is provided, at least in part, as a means by which the user 110 is able to convey payment account information for his/her payment account to the merchant 102 (in order to initiate a payment account transaction for products at or with the merchant 102).

FIG. 3 illustrates an exemplary embodiment of a payment card device 300 that may be used in the system 100 of FIG. 1. In connection therewith, in at least one embodiment, the payment card device 112 in the system 100 may be consistent with (e.g., may be the same as, may include one or more features of, etc.) the payment card device 300 (although this is not required in all embodiments). The payment card device 300 may include, without limitations, a credit card, a debit card, an ATM card, a pre-paid card, or other device, which includes a security chip (e.g., an EMV chip, etc.). However, it should be appreciated that the systems described herein should not be understood to be limited to the payment card device 300, as depicted in FIG. 3, as different payment devices may be used, and conversely, the payment devices described herein should not be limited to the system 100 (as they may be used in other systems, etc.).

As shown in FIG. 3, the illustrated payment card device 300 includes a processor 302, which may include a contact and contactless chip and, as illustrated, incorporates a memory 304 and a modem 306. While a single processor 302 is provided in the payment card device 300, it should be appreciated that multiple such processors (or other chips) may be included in the card device 300 in other payment device embodiments. What's more, in various embodiments, the memory 304 and the modem 306 associated with the processor 302 are often formed integrally, for manufacturability and size constraints associated with the payment card device 300. It should further be appreciated that the memory 304 may include one or more suitable processing units, such as described above (with regard to the processor 202), and the modem 306 may include any suitable device(s), such as described above, each enabling the functions described herein. That said, the processor 302 is configured to perform as described herein (e.g., and, in connection therewith, generally includes a certified secure element including an operating system and payment applet; etc.). In general, the operations performed by the payment card device 300 will be based on the configuration of the processor 302 to perform those operations, unless explicitly provided otherwise. In some embodiments, the payment card device 300 may include a power source (e.g., a battery, etc.) for providing power to the card device 300 (e.g., to the modem 306, etc.). Additionally, the card device 300 may also be configured to be passively powered by a POS terminal (e.g., the POS terminal 102a, etc.) when interacting therewith (as generally known, for example, through use of NFC interactions, etc.).

The modem 306 of the payment card device 300 is configured to wirelessly connect and/or provide communication through one or more telecommunication networks, which may include, for example, cellular networks, some wireless networks, etc. In particular, in one example, the modem 306 is configured to wirelessly connect and/or provide communication through one or more cellular networks and includes a mobile subscriber identity and suitable formatting and/or encryption content to enable communication through the telecommunication network(s), as provided for by the specific cellular network to which the user 110 subscribes. The modem 306 may include a miniaturized modem powered by a power source on the payment card device 300 (e.g., capacitor, battery, etc.), and configured to transmit outgoing messages from the card device 300. The telecommunication networks, in turn, may include cellular networks provided by carriers, such as, for example, Verizon, Sprint, T Mobile, etc., whereby the modem 306 is configured to connect to one or more towers of the cellular network (e.g., within range of the modem 306, etc.) (e.g., ones of the series of towers 116 shown in FIG. 1), etc. Additionally, the telecommunication networks may include wireless networks facilitated by a number of routers disposed across a geographic region (e.g., a business, campus, city, Postal code, etc.), etc. While in the illustrated embodiment, the modem 306 is configured to facilitate (e.g., allow, etc.) only outgoing communications from the payment card device 300 (e.g., for security purposes, for ease of functionality, etc.), it should be appreciated that, in other embodiments, the modem 306 may further be configured to permit wireless connection and/or communication with local wireless networks (e.g., the modem 306 may also receive communications to the payment card device 300 as well as transmit outgoing communications, etc.).

Further, the payment card device 300 is configured to determine its location based on communication with the telecommunication networks (e.g., with one or more cellular networks, one or more wireless networks, combinations thereof, etc.), via the modem 306 and/or the processor 302, through one or more different methods of triangulation (e.g., based on signal strengths from different towers (e.g., intermediary devices, etc.) associated with the cellular network(s) and/or corresponding carrier(s) along with the locations of the towers, or based on signal strengths from different routers (e.g., intermediary devices, etc.) associated with the wireless network(s) along with the locations of the routers, etc.). It should be appreciated that while reference is made to telecommunication networks (e.g., including wireless networks, cellular networks, etc.) herein, such networks will generally include at least one intermediate device to which the modem 306 is configured to communicate. In various embodiments, for example, a card device configured to communicate directly with a POS terminal or other entity (i.e., without an intermediary device), in close proximity, via wireless connections/communications, including, specifically, Bluetooth™, ZigBee™, and RFID, may be excluded from the scope of the modem 306 described herein (and excluded from the telecommunication networks as used herein).

The payment card device 300 also includes a fingerprint sensor 308 configured to capture a fingerprint of the user 110 for use in verifying or authenticating the user 110 (e.g., based on a suitable biometric extraction solution accompanied on the payment card device 300 for use by the fingerprint sensor 308, etc.). The fingerprint sensor 308, as shown in FIG. 3, is located on an opposite side (or an opposite end portion) of the payment card device 300, from the processor 302. In this manner, the payment card device 300 may be inserted into, or tapped onto, a POS terminal (or other terminal or device reader), whereby the POS terminal is able to interface with and/or contact the processor 302, while the fingerprint sensor 308 remains outside the terminal and/or accessible to the user 110. With the fingerprint sensor 308, digital images may be captured and compared to stored fingerprint templates (e.g., stored on the payment card device 300 at the memory 304, etc.) by the processor 302. Such comparison may be based on a suitable biometric algorithm configured to allow for on-card biometric authentication. Match/fail information may then be sent to a payment application of the payment card device 300, for example, in an EMV chip associated with the processor 302, etc., for subsequent use as described herein.

The payment card device 300 further includes a card body 310, which is comprised of plastic of sufficient character to carry the processor 302, the memory 304, the modem 306, and the fingerprint sensor 308 (such that the processor 302, the memory 304, the modem 306, and the fingerprint sensor 308 are generally disposed on the card body 310, and whereby the internal electronic layer associated with such components may be generally flexible in nature to accommodate the plastic construction of the card body 310, etc.). As indicated above, the payment card device 300 is provided consistent with the ISO/IEC 7810 ID-1 standard. As such, as shown in FIG. 3, the card body 310 defines a generally rectangular shape that measures about 85.60 mm (about 3.37 inches) long and about 53.98 mm (about 2.13 inches) wide. The card body 310 also has a thickness of about 0.76 mm (about 0.03 inches). It should be appreciated that the size of the card body 310 may vary slightly and/or as permitted by the standard in various embodiments (e.g., plus or minus about 0.10 mm (about 0.004 inches), about 0.25 mm (about 0.01 inches), about 0.5 mm (about 0.02 inches), about 1 mm (0.04 inches), about 2 mm (about 0.08 inches), about 5 mm (about 0.20 inches), about 10 mm (about 0.39 inches), etc.). What's more, other payment device embodiments may be consistent with one or more other applicable standards related to payment devices, whereby the card body may be sized and/or shaped differently. For example, in other embodiments, payment devices may have horizontal or vertical card designs, or differently shaped edges, etc. In one or more embodiments, payment card devices herein may have (without limitation) dimensions (lengths and/or widths) ranging between about 15 mm (about 0.59 inches) and about 150 mm (about 5.91 inches), and thickness dimensions ranging from about 0.1 mm (about 0.004 inches) to about 1 mm (about 0.04 inches).

With reference again to FIG. 1, when the payment card device 112 is issued to the user 110 by the issuer 108, or more generally, in connection therewith, the user 110 opts to enroll in location services associated with the payment account and specifically the payment card device 112. In addition, at issuance of the payment card device 112, the user 110 will register the payment card device 112 to himself/herself biometrically, whereby the payment card device 112 is configured to capture a biometric from the user 110, for example, via the fingerprint sensor 308, etc., in this embodiment (where the payment card device 112 is consistent with the payment card device 300 of FIG. 3), and to store, in the secure element (SE) of the memory 304, the biometric or representation thereof as a reference biometric. Thereafter, the payment card device 112 is configured to compare captured biometrics in connection with use of the payment card device 112 to the reference biometric stored in the memory 304. It should be appreciated that when the issuer 108 issues the payment account to the user 110, the user 110 will be subject to one or more know-your-customer (KYC) processes, whereby the issuer 108 acquires certain information about the user 110 and confirms the same.

In addition, in the exemplary embodiment, upon the issuance of the payment card device 112, the user 110 enrolls in a mobile or cellular service for the payment card device 112, whereby, like a conventional smartphone, the payment card device 112 is configured and/or enabled to communicate through one or more cellular networks, such as provided by a carrier (e.g., Verizon, Sprint, T Mobile, etc.). The cellular service may be funded by the issuer 108 and/or billed to the payment account as decided by the payment network 106, the issuer 108 and/or the user 110, etc.

In this exemplary embodiment, the carrier (through which the payment card device 112 is enrolled) is configured to determine a location (broadly, location data) of the payment card device 112 through cellular triangulation (based on the cellular network associated with the payment card device 112, etc.). The carrier may then provide the resulting location information for the payment card device 112 to the payment network 106 (either directly, or via a carrier aggregator).

Alternatively, the payment card device 112 may be configured to determine a location (broadly, location data) of the payment card device 112, through use of the cellular network, via the modem 306, and to communicate the location to the payment network 106 and/or the issuer 108. In connection therewith, in this alternative, the payment card device 112 may determine such location through cellular triangulation (based on the cellular network associated with the payment card device 112, etc.), through use of GPS, etc. In one particular example, a location of the payment card device 112 may be determined via cellular tower triangulation (e.g., in response to a location instruction or request by the payment card device 112, etc.), whereby the carrier (through which the payment card device 112 is enrolled) may then provide the resulting location information for the payment card device 112 to the payment card device 112. And, the payment card device 112 may then transmit the location data to the payment network 106, which in turn provides the location data to the issuer 108.

In other embodiments, the payment card device 112 is configured and/or enabled (via the modem 306) to communicate through one or more wireless networks, as provided by one or more routers (e.g., via W-Fi, etc.). In these embodiments, the payment card device 112 may be configured to determine a location (broadly, location data) of the payment card device 112 through the known location of the routers and router triangulation (based on the wireless network associated with the routers, etc.).

The payment card device 112 may be configured to report its location at one or more regular or irregular intervals (either via the corresponding telecommunication network (e.g., via one or more towers of a cellular network, one or more routers of a wireless network, etc.), or through a carrier associated with a cellular network and/or a provider associated with a wireless network, etc.). For example, the payment card device 112 may be configured to push a location (or location instruction) to the issuer 108 (via a cellular network carrier or wireless network provider and/or the payment network 106) every hour, every four hours, every day, every week, or some other interval, etc. as decided by the user 110 and/or the issuer 108, etc. Additionally, or alternatively, the payment card device 112 may be configured to communicate its location (or such location instruction) in connection with a biometric authentication of the user 110 at the payment card device 112, for example, each time the user 110 provides a fingerprint to the fingerprint sensor 308, each time a fingerprint is compared to the reference fingerprint stored in the memory 304, at each use of the payment card device 112 in a transaction, etc.

When the location is received at the payment network 106, the payment network 106 is configured to process the location (e.g., filter the location data indicative of the location, etc.) and provide corresponding location data, or a processed version thereof, to the issuer 108. Like above, the payment network 106 may be configured to provide the location data to the issuer 108 at one or more suitable regular or irregular intervals (e.g., every hour, every four hours, every day, every week, upon receipt from the payment card device 112, etc.). Further, as the user 110 travels from one region to another region (e.g., from a home region in which the user 110 resides to a foreign region (e.g., while on vacation or during business travel, etc.), etc.), the payment card device 112 is configured to continue to communicate (or otherwise provide) its location to the payment network 106, via the modem 306.

In turn, the issuer 108 is configured to receive the location data (or version thereof), associated with the location of the payment card device 112, from the payment network 106. Alternatively, in some embodiments, the issuer 108 may be configured to receive location data directly from the payment card device 112, via the cellular network associated with the payment card device 112 or via a wireless network, etc. (e.g., in parallel with the payment network 106 also receiving such location data from the payment card device 112, or in lieu of the payment network 106 receiving such location data, etc.). The issuer 108, then, is configured to store the location data (e.g., in memory 204, etc.) in connection with the user 110 and/or his/her payment account (and potentially map the location data for the user 110 over time, for a specific interval or otherwise). In addition, the issuer 108 may be configured to adjust a risk model associated with the user's payment account and/or activate or deactivate one or more value added services (VAS's) associated with the payment account based on the received location data (and/or mapping thereof, etc.). For example, in connection with applying a risk model, the issuer 108 may be configured (as an additional input to the risk model) to verify a location of the merchant 102 against the received location of the payment card device 112 to confirm (or otherwise check) that locations match during authorization of a transaction by the user 110 at the merchant (e.g., in connection with evaluating an authorization request for a transaction at the merchant 102 and involving the user's payment account, etc.). The issuer 108 may be further configured to push content related to the location to the user 110. For example, in response to receiving the location data for the payment card device 112, the issuer 108 may be configured (as part of one or more value added services provided by the issuer 108) to transmit targeted offers, discounts, coupons, etc., for a merchant in the vicinity of the user 110 (based on the location data). In particular, the issuer 108 may be configured to provide the discounts, offers, coupons, etc. through SMS or application messaging to the user's communication device 114, etc.

Then in the system 100, when the user 110 desires to initiate a transaction at the merchant 102 funded by the payment account, the user 110 presents the payment card device 112 to the merchant 102 (and, in particular, to the POS terminal 102a at the merchant 102). When the POS terminal 102a permits partial insertion of the payment card device 112 (e.g., has chip-reading capabilities, etc.), so that the fingerprint sensor 308 remains accessible upon insertion of the processor 302 into the POS terminal 102a, the user 110 provides a fingerprint to the exposed fingerprint sensor 308. The payment card device 112, in turn, is configured to capture the fingerprint, via the fingerprint sensor 308, and to authenticate the user 110 against the reference biometric (specifically, the reference fingerprint) stored in memory 304 (e.g., is configured to determine that the fingerprint received at the sensor 308 (or a template thereof) matches the reference fingerprint (or a template thereof), etc.). And, when the user 110 is authenticated, the payment card device 112 is configured to indicate (e.g., via an authentication result or other authentication information provided by the payment card device 112 to the POS terminal 102a, etc.) the authentication in or to the POS terminal 102a of the merchant 102, and thereby instruct the POS terminal 102a to skip other verification of the user 110 and to transmit the full transaction to the issuer 108 for authentication. In turn, the POS terminal is then configured to indicate the biometric match (i.e., the result of the match (e.g., successful match, unsuccessful match, ninety-percent confidence match, etc.) as part of an authorization request compiled (by the POS terminal 102a) for the transaction. In general, the POS terminal 102a will not have access to the actual biometric data received and used by the payment card device 112 to determine the match (i.e., the biometric information on which the user authentication is based), as this will be maintained at the payment card device 112.

In response, the merchant 102 (e.g., the POS terminal 102a, etc.) is configured to transmit the authorization request for the transaction to the payment network 106, via the acquirer 104, and the payment network 106 is configured to pass the authorization request on to the issuer 108. The issuer 108 is then configured to decide to approve or decline the transaction based, at least in part, on the authentication indicator (or indication) included in the authorization request and potentially subject to other requirements of the issuer 108 (e.g., payment account balance, credit limit, standing, etc.). The issuer 108 then generates an authorization reply consistent with its decision, and transmits the authorization reply back to the merchant 102 (e.g., to the POS terminal, etc.) via the payment network 106 and the acquirer 104. The transaction then proceeds consistent with the issuer's decision in the authorization reply.

Conversely, if the POS terminal 102a at the merchant 102 consumes or swallows the payment card device 112, such that the fingerprint sensor 308 is not accessible to the user 110, the authentication information provided by the payment card device 112 to the POS terminal 102a will not include an authentication indicator. As such, the POS terminal 102a will not include any authentication indicator in the authorization request transmitted to the issuer 108 (again, via the acquirer 104 and the payment network 106). In this example, when the authorization request is received, at the issuer 108, the issuer 108 is configured to identify the transaction as lacking the authentication indicator (e.g., as non-biometric authenticated (based on the authentication information in the authorization request), etc.) and to retrieve a location of the user 110, as provided via the modem 306 of the payment card device 112 (through the payment network 106, etc. as generally described above). When the location is consistent with a merchant location for the merchant 102 (e.g., as included in the authorization request, etc.), the issuer 108 may be configured to approve the transaction, subject to other requirements of the issuer 108 (e.g., payment account balance, credit limit, standing, etc.). Alternatively, when the location is inconsistent with a merchant location for the merchant 102 (in general or as included in the authorization request), the issuer 108 may be configured to decline the transaction (on that basis alone).

Additionally or alternatively, in this later example where the POS terminal 102a consumes or swallows the payment card device 112, the issuer 108 may be configured to direct the user 110 to interact with the payment card device 112, via an SMS message or application message to the communication device 114. In particular, for example, the issuer 108 may direct the user 110 to authenticate at the payment card device 112. In such an embodiment, the user 110 will remove the payment card device 112 from the POS terminal 102a at the merchant 102, in order to access the fingerprint sensor 308, and proceed to present a fingerprint to the fingerprint sensor 308 of the payment card device 112. In connection therewith, the payment card device 112 is configured to capture the fingerprint, from the user 110, at the fingerprint sensor 308, and to authenticate the user 110 against the reference fingerprint stored in memory 304 (as described above). The payment card device 112 is then configured to transmit an authentication result, either authenticated or not authenticated, to the issuer 108, via the modem 306. The authentication result may be provided directly to the issuer 108, or through the payment network 106 (in similar fashion to the location data). When the authentication result is received at the issuer 108, and when the result indicates authentication of the user 110, the issuer 108 may then instruct the user 110 to restart the transaction (e.g., insert the payment device into the POS terminal 102a, etc.), if the prior transaction was declined, whereby the issuer 108 is then configured to approve or decline the subsequent transaction based on the newly received authentication result and, again, potentially other criteria as conventionally relied on by the issuer 108.

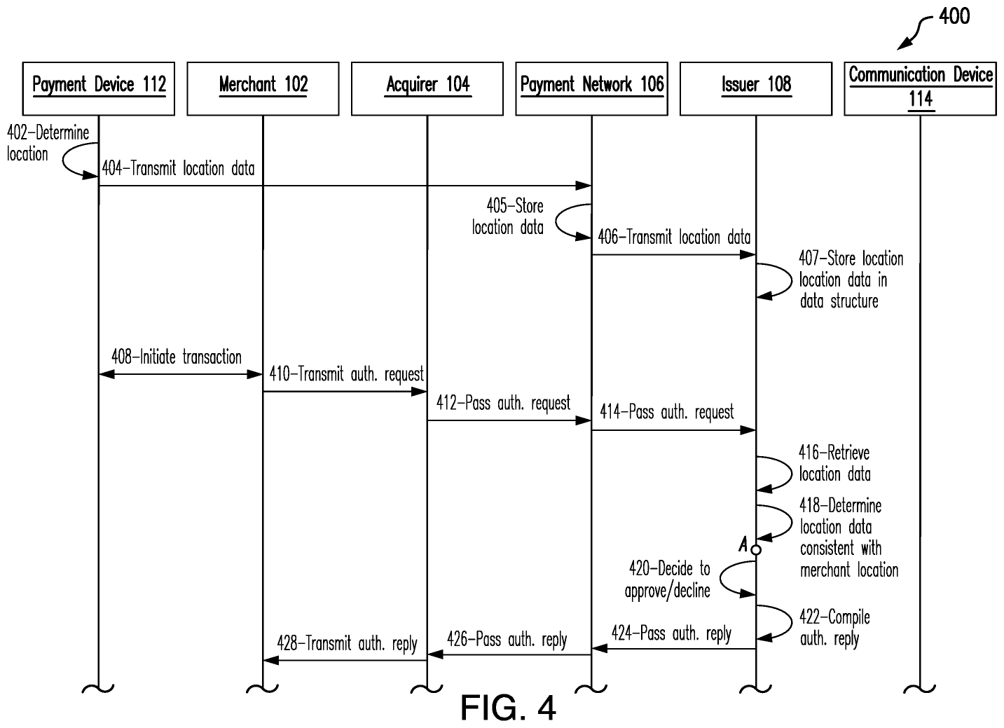

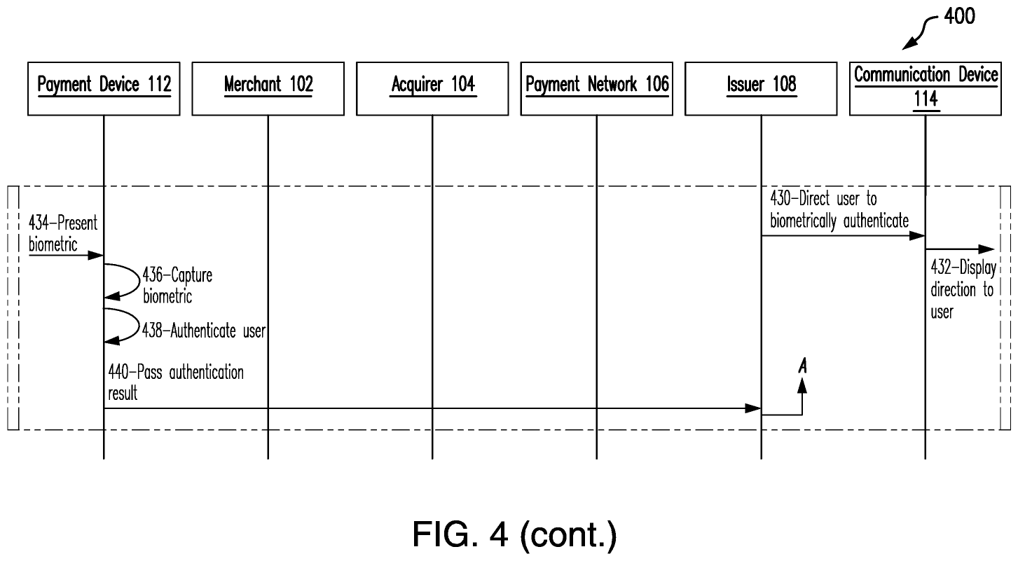

FIG. 4 illustrates an exemplary method 400 of verifying a user, in connection with a transaction by the user, using a payment device associated with the user. The method 400 is described below in connection with the exemplary system 100, the exemplary computing device 200, and the exemplary payment card device 300 previously described. However, it should be appreciated that the method 400 is not limited to the system 100, or the computing device 200, or the payment card device 300, but may be implemented in a variety of different systems and/or computing devices and/or payment devices. Likewise, the systems, computing devices, and payment devices described herein should not be understood to be limited to the exemplary method 400, or other methods described herein.

As previously described, the payment card device 112 is issued to the user 110 by the issuer 108, and can be used in transactions, such as to purchase products from the merchant 102, etc. (whereby the transactions are then funded by the user's payment account). The payment card device 112 is registered to the user 110, such that there is a reference biometric stored therein (e.g., in a secure element of memory 304 of the payment card device 112, etc.) and, in this embodiment, the payment card device 112 is enrolled with a carrier, whereby the payment card device 112 is enabled to communicate via the modem 306 (as described herein), through a cellular network provided by the carrier or through a wireless network (e.g., by another provider, etc.) to which the payment card device 112 connects via the modem 306.

At the outset in method 400, the payment card device 112 determines its location, via the modem 306, at 402, and transmits, at 404, location data indicative of the location to the payment network 106, via the modem 306 included therein and over a telecommunication network (e.g., via one or more towers of a cellular (e.g., of the series of towers 116 in FIG. 1, etc.) or mobile network, via one or more routers of a wireless network, etc.) to which the modem 306 connects. In connection therewith, the payment card device 112 may determine its location via cellular tower triangulation, wireless router triangulation, etc. based on the device's cellular network and/or wireless network and obtain the corresponding location data therefrom. Or, alternately, the payment card device 112 may obtain the corresponding location data from the carrier associated with the cellular network and/or the provider associated with the wireless network. In either case, once the location data is received, the payment card device 112 then transmits the location data to the payment network 106. As a further alternative, the cellular carrier (through which the payment card device 112 is enrolled) may be configured to determine the location of the payment card device 112, for example, through cellular triangulation (based on the cellular network associated with the payment card device 112, etc.). And, the carrier provides the resulting location for the payment card device 112 to the payment network 106 (either directly, or via a carrier aggregator).

At 405, the payment network 106 in turn stores (e.g., in a data structure, etc.) and processes the location data as appropriate and then transmits, at 406, the location data to the issuer 108 (e.g., after translating the location data into a desired format for the issuer 108, etc.). The location data may be transmitted to the issuer 108 via the payment network 106, as shown in FIG. 4, or directly to the issuer 108. And, as described above, the location data may be transmitted, from the payment card device 112 to the payment network 106 (via one or more of the series of towers 116 in FIG. 1, as provided by the carrier of a cellular network, or via one or more routers, as provided by the provider of a wireless network), at one or more regular (e.g., pre-programmed, etc.) or irregular intervals. For example, the location data may be transmitted every hour, every day, or at longer or shorter intervals (or durations), or the location data may be reported upon an event, such as, for example, a particular strength and/or accessibility associated with a cellular network and/or a wireless network, or a detection of a departure of the user 110 from a native region (e.g., based on a Postal code, city, state, country, etc., in which the user 110 resides, etc.), etc. In at least one embodiment, the payment card device 112 transmits a location each time a transaction is attempted. Similarly, the location data may be transmitted from the payment network 106 to the issuer 108 at one or more regular or irregular intervals. For example, the payment network 106 may transmit all location data to the issuer 108 when received, or the payment network 106 may only transmit location data to the issuer 108 at certain times or in response to certain events (e.g., upon detection of a departure of the user 110 from a native region (e.g., based on a postal code, city, state, country, etc., in which the user 110 resides, etc.), upon detection of a return of the user 110 to the native region, based on a specified distance traveled by the user 110, based on a presence of the user 110 in a particular city or state or country, in response to an authorization request for a transaction, etc.). As such, two different layers of rules may be used to determine when the location data is transmitted (one set of rules at the payment card device 112 and another set of rules at the payment network 106).

In connection with the above, it should be appreciated that when the payment card device 112 transmits the location data to the payment network 106, the payment network 106 stores and/or filters (broadly, processes) the location data as it is passed to the issuer 108 for one or more reasons as described herein. In one example, the payment network 106 (acting as the intermediary) may pass the processed location data to the issuer 108 only upon request by the issuer 108 (or the user 110). While in another example, the payment network 106 may pass the location data at one or more intervals agreed upon between the issuer 108 and the payment network 106, etc.

In any case, when the location data for the payment card device 112 is received at the issuer 108, the issuer 108 stores, at 407, the location data in a location data structure in memory (e.g., in memory 204 associated with the issuer 108, etc.). The location data structure, in general, will link the location data to the payment account of the user 110. Table 1 illustrates an exemplary entry into such a location data structure whereby a location of the payment card device 112 is recorded to the payment account of the user 110 (and whereby the entry may be generated by the issuer 108 and stored in the location data structure, or the entry may be generated provided by the payment network 106 to the issuer 108 for storage). While the illustrated entry includes a payment account number for the user's payment account, it should be appreciated that this may not be required in all embodiments. For example, the device ID for the user's communication device may instead be linked to the user's payment account, whereby the device ID may be a sufficient identifier for the account.

TABLE 1

| Location | Date/Time | Payment Account No. | Device ID |
|---|---|---|---|
| 123 Main Street, | MM:DD:YY | 1234-1234-1234-1234 | 123456 |
| City, State, 55555 | @HH:MM:SS | | |

As explained above, the payment card device 112 will continue to transmit location data at one or more intervals (or otherwise), in this embodiment, and the payment network 106, upon receipt, will continue to store and process the location data as appropriate. The payment network 106 will then also continue to transmit the location to the issuer 108 at appropriate times (e.g., in response to particular events as described above, etc.), whereby the issuer 108 will continue to store the location data in the location data structure (whereby the location data structure may include multiple entries similar to that in Table 1). In at least one embodiment, the issuer 108 deletes location data received from the payment card device 112, except for a last entry or multiple last entries in the location data structure, for example, to promote the privacy of the user 110. It should further be appreciated that the location data structure may be specific to the user 110 or the payment account, or may be generic to multiple users and/or payment accounts.

With continued reference to FIG. 4, separately in the method 400, the user 110 may interact with the merchant 102 and decide to purchase one or more products from the merchant 102. In so doing, the user 110 initiates, at 408, a transaction by presenting the payment card device 112 to the merchant 102 and/or the POS terminal 102a associated with the merchant 102. In connection therewith, the transaction is initiated between the merchant 102 and the payment card device 112. The interaction may include, for example, the POS terminal 102a interrogating the payment card device 112 for a card verification method (CVM) list indicative of the biometric authentication capabilities of the payment card device 112, determining that the transaction includes a card-present transaction, etc. For example, the payment card device 112 and/or POS terminal 102a may initiate a timer to receive a fingerprint (broadly, a biometric) at the fingerprint sensor 308.

In this exemplary embodiment, the POS terminal 102a “swallows” or envelops the payment card device 112, whereby the fingerprint sensor 308 is not accessible to the user 110 and the user 110 is not able to provide a fingerprint for biometric authentication. As such, the payment card device 112 and/or the POS terminal 102a causes the transaction to proceed without the biometric authentication of the user 110, despite the inclusion of the biometric sensor 308 in the payment card device 112. In connection therewith, the merchant 102, and specifically, the POS terminal 102a, compiles and transmits, at 410, an authorization request for the transaction to the acquirer 104. Among other things, the authorization request includes a transaction amount for the transaction, a merchant identifier for the merchant 102, a merchant address for the merchant 102, a primary account number (PAN) for the user's payment account, acquirer information for the acquirer 104, an indication that the transaction is a card-present transaction, etc. In addition, the authorization request includes an indicator of a biometric authentication having failed or not being attempted (or simply includes a lack of such indicator all together).

At 412, the acquirer 104 passes the authorization request to the payment network 106. And, then, at 414, the payment network 106 passes the authorization request to the issuer 108.

Upon receipt of the authorization request, the issuer 108, among other things, identifies the transaction as associated with a payment device that includes a biometric sensor (e.g., based on the PAN of the user's payment account being within a range of PANs, etc.) and determines that the biometric authentication was not completed, based on the indicator included in the authorization request (or lack thereof). Then, the issuer 108 retrieves, at 416, location data for the payment account and/or the user 110, based on the PAN in the authorization request (or potentially based on the device ID included in the authorization request for the user's payment card device 112 where the PAN is not directly included in the location data structure, etc.), from the location data structure in memory (e.g., in memory 204, etc.). In general, the issuer 108 will retrieve the most recently stored location data (as received from the payment network 106, etc.). The issuer 108 then determines, at 418, whether the location data retrieved for the user 110 and/or the payment account is consistent with the merchant location of the merchant 102 identified in the authorization request. For example, the issuer 108 may be configured to compare the most recent location for the user 110 with the location of the merchant 102 and determine if the two locations are within an acceptable distance of each other (e.g., to determine if the two locations exactly match, to determine if the two locations are within the same 0.25 mile radius, etc.). In connection therewith, the issuer 108 may include a location engine configured to determine a difference between the two locations, and provide approval of the transaction based on a proximity between the two locations being within a predefined value.

In turn, the issuer 108 determines whether to approve or decline the transaction, at 420. The determination is based, at least in part, on whether the location data was consistent or inconsistent with the merchant location indicated in the authorization request (e.g., whether the two locations were within a predefined distance or radius of each other, such as 500 feet, 1000 feet, 0.25 miles, 1 mile, 5 miles, etc.; whether the two locations were within the same zip code; etc.). It should be appreciated that the approval or decline may be further based on other aspects of the user's payment account and/or the transaction itself (e.g., fraud score, account balance, etc.).

The issuer 108 then compiles an authorization reply, at 422, and transmits the authorization reply to the payment network 106, at 424. The payment network 106 then passes the authorization reply to the acquirer 104, at 426, which then passes the authorization reply to the merchant, at 428. When the transaction is approved, the merchant 102 proceeds to deliver the product or service purchased by the user 110 to the user 110. If, however, the transaction is declined, the merchant 102, for example, may seek alternate forms of funding for the transaction.

Optionally in the method 400 (as indicated by the dotted box in FIG. 4), when the issuer 108 determines, at 418, that the location data is consistent (or not) with the merchant location, the issuer 108 may further direct, at 430, the user 110 to perform a biometric authentication at the payment card device 112. This may include, for example, a direction to the user 110 via the communication device 114, as a SMS message or an application message to a network-based application therein. In response, the communication device 114 display, at 432, the direction to the user 110. The user 110, in turn, retrieves the payment card device 112 from the merchant 102, or the POS terminal 102a, and presents, at 434, a fingerprint to the fingerprint sensor 308 of the payment card device 112.

The payment card device 112 then captures, at 436, the fingerprint of the user 110, via the fingerprint sensor 308, and authenticates the user 110, at 438, based on a comparison of the captured fingerprint to a reference fingerprint stored in the payment card device 112. When the user 110 is authenticated (i.e., there is a sufficient match as would be understood by one skilled in the art) or not, the payment card device 112 transmits, at 440, an authentication result indicative that the user 110 was authenticated, or not, to the issuer 108 (via the modem 306 over a telecommunication network (e.g., via one or more towers of a cellular or mobile network, via one or more routers of a wireless network, etc.) to which the modem 306 connects, etc.). Upon receipt of the authentication result, the issuer 108 returns, as shown in FIG. 4, to point A, where after the issuer 108 decides to approve or decline the transaction based on the authentication result and one or more other criteria known to the issuer 108, and proceeds consistent with method 400 for the transaction. Alternatively, the user 110 may be instructed (or may be required) to restart the transaction (e.g., insert the payment card device 112 into the POS terminal 102a, etc.), if the prior transaction was declined or terminated, whereby the issuer 108 is then configured to approve or decline the subsequent transaction based on the newly received authentication result (e.g., upon receipt of the authorization request for the subsequent transaction, etc.) and, again, potentially other criteria as conventionally relied on by the issuer 108.

In another example embodiment, a computer-implemented method for authenticating a user in connection with a network transaction by the user generally includes receiving, by a computing device, from a payment card device associated with the user, location data for the payment device; storing, by the computing device, the location data in a data structure in association with the payment device; receiving, by the computing device, via a payment network, an authorization request for a network transaction initiated by the user to a payment account associated with the payment card device; determining, by the computing device, based on the authorization request for the network transaction, that biometric authentication of the user was not completed for the network transaction; retrieving, by the computing device, the location data for the payment card device from the data structure; and in response to the retrieved location data for the payment card device matching location data included in the authorization request, generating, by the computing device, an approval for the network transaction.

In some aspects, the example computer-implemented method may further include, in response to the retrieved location data for the payment device not matching the location data included in the authorization request, generating, by the computing device, a decline for the network transaction. And, the method may then include generating, by the computing device, a response to the authorization request including either the approval or the decline, and transmitting the response to the payment network.

In some aspects, the example computer-implemented method may further include, after receiving the authorization request, transmitting a direction to the user to present a biometric to the payment device to thereby complete biometric authentication of the user for the network transaction. The method may then include receiving, by the computing device, via a modem of the payment device, an authentication result for the completed biometric authentication of the user, wherein the authentication result indicates that the user is either authenticated or not authenticated. In connection therewith, generating the approval for the network transaction may include generating the approval in response to the retrieved location data for the payment device matching the location data included in the authorization request and the authentication result indicating that the user is authenticated. Further, the payment device may include a payment card having a fingerprint sensor; and receiving an authentication result for the completed biometric authentication of the user may include receiving an authentication result for a completed fingerprint authentication of the user.

In view of the above, the systems and methods herein generally enable a mobile biometric device location alert service, in which location data for payment devices is recorded and used, as needed, to subsequently authenticate use of the payment devices, for example, in transactions with merchants. In connection therewith, the payment devices of the systems and methods herein include modems, whereby the payment devices are enabled to provide such location data to issuers of the devices. Additionally, the payment devices are enabled, via the modems, to also provide biometric data to the issuers for use in authenticating the users in connection with the transactions. As such, the payment devices of the present disclosure enable different means of authentication, whereby improper decline of transactions may be avoided. What's more, when biometric authentication is not available at a merchant, the issuer of the user's payment account is provided further location data upon which to decide to approve or decline the transaction.

It should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by one or more of: (a) receiving, by a computing device, from a payment device associated with a user, location data for the payment device; (b) storing, by the computing device, the location data in a data structure in association with the payment device; (c) receiving, by the computing device, via a payment network, an authorization request for a network transaction initiated by the user via the payment device; (d) determining, by the computing device, based on the authorization request for the network transaction, that biometric authentication of the user was not completed for the network transaction; (e) retrieving, by the computing device, location data for the payment device from the data structure; (f) in response to the retrieved location data for the payment device matching location data included in the authorization request, generating, by the computing device, an approval for the network transaction; (g) in response to the retrieved location data for the payment device not matching the location data included in the authorization request, generating, by the computing device, a decline for the network transaction; (g) generating, by the computing device, a response to the authorization request including either the approval or the decline, and transmitting the response to the payment network; (h) after receiving the authorization request, transmitting a direction to the user to present a biometric to the payment device to thereby complete biometric authentication of the user for the network transaction; (i) receiving, by the computing device, from the payment device, an authentication result for the completed biometric authentication of the user, wherein the authentication result indicates that the user is either authenticated or not authenticated; (j) determining, by the payment device, a location of the payment device, via a modem of the payment device; and (k) transmitting, via the modem, location data indicative of the determined location to at least one of an issuer of the payment account and a payment network associated with the payment account.

As will also be appreciated based on the foregoing specification, the above-described embodiments of the disclosure may be implemented using computer programming or engineering techniques including computer software, firmware, hardware or any combination or subset thereof, wherein the technical effect may be achieved by one or more of: (a) determining, by a processor of a payment card associated with a payment account, a location of the payment card, via at least a modem of the payment card, based on multiple signals from multiple towers (and/or multiple routers) associated with a telecommunication network; (b) transmitting, by the modem, via one of the multiple towers and/or multiple routers, location data indicative of the determined location to at least one of an issuer of the payment account and/or a payment network associated with the payment account; (c) capturing, by the processor, via a fingerprint sensor of the payment card, a fingerprint of a user in response to a transaction involving the payment account; (d) comparing, by the processor, the captured fingerprint to a reference fingerprint stored in memory of the payment card; (e) compiling, by the processor, an authentication result based on the comparison of the captured fingerprint and the reference fingerprint; (f) transmitting, by the modem, via one of the multiple towers and/or one of the multiple routers, the authentication result to at least one of the issuer and/or the payment network; and (g) providing, by the processor, payment account credentials for the payment account to a point-of-sale (POS) terminal.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A payment card device associated with a payment account, the payment card device comprising:
a card body defining a length dimension between about 15 mm and about 150 mm, a width dimension between about 15 mm and about 150 mm, and a thickness dimension between about 0.1 mm and about 1 mm;
a modem disposed on the card body; and
a processor disposed on the card body and coupled to the modem, wherein the processor is configured to:
determine a location of the payment card device, via at least the modem, based on multiple signals associated with a telecommunication network; and
transmit, by the modem, location data indicative of the determined location to an entity associated with the payment account.

2. The payment card device of claim 1, wherein the modem is integrated with the processor.

3. The payment card device of claim 2, wherein the card body defines a generally rectangular shape having a length dimension of about 85.60 mm, a width dimension of about 53.98 mm, and a thickness of about 0.76 mm.

4. The payment card device of claim 1, wherein the processor is configured to determine the location of the payment card device and transmit the location data indicative of the determined location at a predefined interval.

5. The payment card device of claim 1, wherein the entity includes at least one of an issuer of the payment account and/or a payment network, and wherein the telecommunication network includes a cellular network; and
wherein the payment card device further comprises:
a fingerprint sensor disposed on the card body and coupled to the processor; and
a memory coupled to the processor;
wherein the processor is further configured to:
capture, via the fingerprint sensor, a fingerprint of a user;
compare the captured fingerprint to a reference fingerprint stored in the memory;
compile an authentication result based on the comparison of the captured fingerprint and the reference fingerprint; and
transmit, by the modem, via one of multiple towers associated with the cellular network, the authentication result to at least one of the issuer and/or the payment network.

6. The payment card device of claim 5, wherein the processor includes the memory; and
wherein the fingerprint sensor and the processor are disposed at opposite end portions of the card body.

7. The payment card device of claim 1, wherein the processor is further configured to provide payment account credentials for the payment account, stored in a memory of the payment card device, to a point-of-sale (POS) terminal.

8. The payment card device of claim 1, wherein the payment card device is enrolled with the telecommunication network, and wherein the processor is configured to transmit the location data indicative of the determined location to the entity further via a carrier associated with the telecommunication network.

9. The payment card device of claim 1, wherein the entity includes at least one of an issuer of the payment account and/or a payment network.

10. A computer-implemented method for authenticating a user in connection with a network transaction by the user, the computer-implemented method comprising:
determining, by a processor of a payment card associated with a payment account, a location of the payment card, via at least a modem of the payment card, based on multiple signals from multiple towers associated with a telecommunication network; and
transmitting, by the modem, via one of the multiple towers, location data indicative of the determined location to at least one of an issuer of the payment account and/or a payment network associated with the payment account.

11. The computer-implemented method of claim 10, further comprising:
capturing, by the processor, via a fingerprint sensor of the payment card, a fingerprint of a user in response to a transaction involving the payment account;
comparing, by the processor, the captured fingerprint to a reference fingerprint stored in memory of the payment card;
compiling, by the processor, an authentication result based on the comparison of the captured fingerprint and the reference fingerprint; and
transmitting, by the modem, via one of the multiple towers, the authentication result to at least one of the issuer and/or the payment network.

12. The computer-implemented method of claim 10, further comprising providing, by the processor, payment account credentials for the payment account to a point-of-sale (POS) terminal.

13. The computer-implemented method of claim 10, wherein the payment card defines a generally rectangular shape having a length dimension of about 85.60 mm, a width dimension of about 53.98 mm, and a thickness of about 0.76 mm.

14. A system for authenticating a user in connection with a network transaction by the user, the system comprising an issuer computing device coupled to a payment network, the issuer computing device configured to:
receive, from a payment card device associated with a user, via a modem of the payment card device, location data for the payment card device;
store the location data in a data structure in association with a primary account number (PAN) for a payment account associated with the payment card device and/or a device identifier for the payment card device;
receive, via the payment network, an authorization request for a network transaction including the PAN and/or involving the payment account associated with the payment card device;
determine, based on the authorization request for the network transaction, that biometric authentication of the user was not completed for the network transaction;
retrieve the location data for the payment card device stored in the data structure based on the PAN for the payment account associated with the payment card device and/or the device identifier for the payment card device;
compare the retrieved location data for the payment card device to location data included in the authorization request; and
generate a response to the authorization request based at least on the comparison.

15. The system of claim 14, wherein the issuer computing device is further configured, after receiving the authorization request, to:
transmit a direction to the user to present a biometric to the payment card device; and
receive, from the payment card device, via the modem of the payment card device, an authentication result for the completed biometric authentication of the user, wherein the authentication result indicates that the user is either authenticated or not authenticated.

16. The system of claim 15, wherein the issuer computing device is further configured, in response to the retrieved location data for the payment card device matching the location data included in the authorization request and the authentication result for the completed biometric authentication of the user indicating that the user is authenticated, to generate an approval for the network transaction and include the approval in the response to the authorization request.

17. The system of claim 15, wherein the issuer computing device is further configured, in response to the retrieved location data for the payment card device not matching the location data included in the authorization request and the authentication result for the completed biometric authentication of the user indicating that the user is authenticated, to generate an approval for the network transaction and include the approval in the response to the authorization request.

18. The system of claim 14, further comprising the payment card device;
wherein the payment card device includes:
a card body;
the modem disposed on the card body; and
a processor disposed on the card body and coupled to the modem, wherein the processor is configured to transmit, via the modem, the location data for the payment card device to the issuer computing device.
